(19) United States
(12) Patent Application Publication
(10) Pub. No.: US 2025/0293875 A1
(43) Pub. Date: Sep. 18, 2025

(54) DISTRIBUTION OF SECURITY KEYS IN A STORAGE NETWORK

(71) Applicant: Hewlett Packard Enterprise Development LP, Spring, TX (US)

(72) Inventors: Kirill Malkin, Berkeley Heights, NJ (US); Krishna Babu Puttagunta, Rocklin, CA (US); Prateek Sarnad, Bangalore (IN)

(21) Appl. No.: 18/677,668

(22) Filed: May 29, 2024

(30) Foreign Application Priority Data
Mar. 14, 2024 (IN) 202411018676

(51) Int. Cl. H04L 9/08; H04L 9/32; H04L 9/40

(52) U.S. Cl. CPC H04L 9/0891; H04L 9/0861; H04L 9/088; H04L 9/32; H04L 63/0428; H04L 63/20

(57) ABSTRACT

Example implementations relate to storage networks. In some examples, a controller identifies a set of devices associated with a zone configuration of a storage network, and identifies a set of policies associated with the zone configuration. The controller generates a set of security keys based on the set of devices and the set of policies. The controller distributes the set of security keys to the set of devices via a set of secure messages, where the set of devices receive different subsets of the set of security keys to establish encrypted communications among the set of devices.

### BRIEF DESCRIPTION OF THE DRAWINGS

Some implementations are described with respect to the following figures.

FIGS. 1A-1B are schematic diagrams of an example storage network, in accordance with some implementations.

FIG. 2 is an illustration of an example operation, in accordance with some implementations.

FIG. 3 is an illustration of an example process, in accordance with some implementations.

FIG. 4 is an illustration of an example operation, in accordance with some implementations.

FIG. 5 is an illustration of an example operation, in accordance with some implementations.

FIG. 6 is a schematic diagram of an example computing device, in accordance with some implementations.

FIG. 7 is an illustration of an example process, in accordance with some implementations.

FIG. 8 is a diagram of an example machine-readable medium storing instructions in accordance with some implementations.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In some examples, a storage network system may include compute nodes and storage devices coupled via network links (also referred to herein as a “network fabric”). For example, such network links may be implemented using the Non-Volatile Memory Express over Fabrics (NVMe-oF) protocol. In some examples, the storage network system may include physical storage devices, physical compute nodes, physical switch devices, virtual storage devices, virtual compute nodes, virtual switch devices, or any combination thereof. A storage device may include or manage any number of storage components to persistently store data. For example, a storage device may be a controller for a storage array including multiple non-volatile storage drives. A compute node may be a computing device (e.g., a server, controller, etc.) that can access the data stored in the storage devices. Each compute node and storage device may be referred to as a terminal or “endpoint” device that sends or receives data packets via the network fabric. As used herein, a “source device” may be the endpoint device that generates a packet, and a “destination device” may be the endpoint device that receives the packet. Further, a “switch device” may be a network device that can direct and/or transfer data between the endpoint devices.

In some examples, the devices of the storage network system may be separated into different groups or “zones” to provide data privacy and/or security. The zones may be defined by access rules (also referred to herein as “zone rules”) that specify how data may be accessed in the zones. The zones rules may be evaluated and applied by switch devices that receive packets for forwarding to their respective destinations. For example, a switch device may include a first zone rule that identifies a first source device that is allowed to send packets to a destination device, but does not include any zone rules that allow a second source device to send packets to the destination device. In this example, the switch device will allow a first packet to be sent from the first source device to the destination device, but will block a second packet that is sent from the second source device to the destination device. In this manner, the zone rules may prevent devices from communicating with and/or accessing the devices in a different zone. As used herein, the term “zoning” may refer to controlling (e.g., allowing or blocking) communication between devices based on their assigned zones.

In some examples, the messages between endpoint devices in a zone may be protected by one or more security techniques. For example, in a storage network using the NVMe-oF protocol, the messages may be authenticated using Diffie-Hellman-Hash-based Message Authentication Code-Challenge-Handshake Authentication Protocol (DH-HMAC-CHAP), may be encrypted using Transport Layer Security (TLS) protocols, or a combination thereof. Each endpoint device in a zone may be provided with one or more secret values (also referred to herein as “security keys”) for authenticated and/or encrypted communications with other devices in the same zone. For example, a zone may include different pairs of devices (e.g., a combination of host device and storage controller) that are allowed to communicate with other. In such examples, each device in a pair may be provided with a “self” key to authenticate itself to the other device (referred to as the “partner” device) in that pair. Further, each device in the pair may be provided with a “partner” key to authenticate the partner device in that pair. In some examples, the management of security keys in a storage network may be complicated and error prone. For example, manually generating different and secure sets of keys for each pair of devices in a zone may be a complicated and time-consuming task. Further, it may be difficult to correctly distribute each key to the appropriate device, while also maintaining the secrecy of each key. Furthermore, because there may be multiple keys for each allowed pairing of devices in a zone, the difficulty of generating and distributing the keys may rise rapidly (e.g., exponentially) when the number of devices is increased.

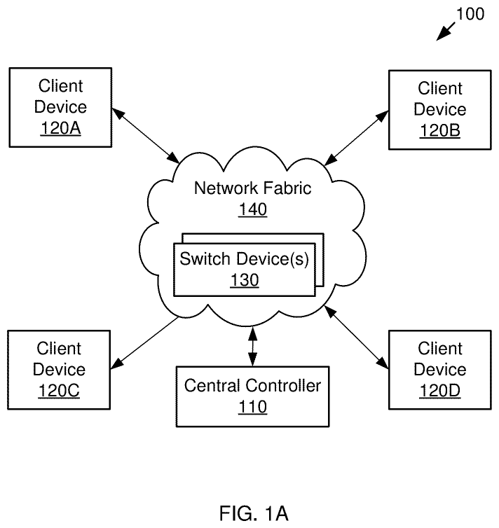

As described further below with reference to FIGS. 1A-8, some implementations may include a central controller that provides a service (referred to herein as a Key Discovery Service (KDS)) to generate and distribute security keys to devices in a storage network. Each device in the storage network (also referred to herein as a “client” of the central controller) may be assigned a client key to authenticate messages from the central controller. The central controller may determine which client devices are allowed to communicate with each other in each zone of the storage network, and may also determine the security techniques to be applied to such communications. The central controller may then generate the appropriate set of security keys for each client device (e.g., a self-key and multiple partner keys), and may distribute the sets of security keys to the client devices in messages that are authenticated via the client keys. In this manner, the central controller may automatically generate and distribute the appropriate security keys to multiple client devices in a secure manner. Accordingly, some implementations described herein may improve the use and management of security keys in the storage network.

### FIGS. 1A-1B—Example Network System

FIG. 1A shows an example of a network system 100, in accordance with some implementations. The network system 100 may include any number and type of devices, including a central controller 110, client devices 120A-120D, and one or more switch devices 130. The client devices 120A-120D (also referred to herein as “client devices 120”) may be physical and/or virtual devices, including compute nodes, storage devices, or components thereof. For example, the client device 120A may be a computing device or host (e.g., a computer server including a processor, memory, and persistent storage). Further, in this example, the client device 120B may be all or part of a storage device (e.g., storage subsystem, storage controller, storage array, hard disk drive(s), solid state drive(s), optical disk(s), and so forth). In this example, the client device 120A may send a request to obtain data stored in the client device 120B. Further, a switch device 130 may transfer the request from the client device 120A to the client device 120B. The switch device 130 and the client devices 120 may be interconnected by any number of links in a network fabric 140. A “link” can refer to a communication medium (wired and/or wireless) over which devices can communicate with one another. In some implementations, the central controller 110 may be a Centralized Discovery Controller (CDC) that provides automated discovery of devices in an NVMe-oF network system. An example implementation of the central controller 110 is described below with reference to FIG. 1B.

In some implementations, each client device 120 may include a user application (also referred to herein as a “client agent”) that is used to perform Key Discovery Service (KDS) operations by interacting with the central controller. In other implementations, each client device 120 does not include a client agent, and the central controller 110 performs KDS operations on the client device 120 via a remote access connection (e.g., using a Secure Shell Protocol (SSH) or HTTPS connection).

In some implementations, the network system 100 can be configured for a particular task or purpose. For example, in some implementations, the network system 100 may be a Storage Area Network (SAN) implementing one or more network protocols (e.g., the NVMe-oF protocol, the Internet Small Computer Systems Interface (iSCSI) protocol, and so forth). Although FIG. 1A shows an example implementation of the network system 100, other implementations are possible. For example, it is contemplated that the network system 100 may include additional devices and/or components, fewer components, different components, different arrangements, and so forth.

Referring now to FIG. 1B, shown is an example implementation of a central controller 110. In some implementations, the central controller 110 may include a discovery engine 112, a configuration engine 114, a client engine 115, a security key engine 116, and a device database 118. Some or all of the engines 112, 114, 115, 116 may be implemented via hardware (e.g., electronic circuitry), or via a combination of hardware and programming (e.g., comprising at least one processor and instructions executable by the at least one processor). In implementations using executable instructions, such instructions may be stored in machine-readable storage media, in hardware (e.g., circuitry), and so forth. Although FIG. 1B shows an example in which the engines 112, 114, 115, 116 are implemented in a single central controller 110, in other examples, the engines 112, 114, 115, 116 may be implemented in distinct devices or services. Further, it is contemplated that the central controller 110 may include additional devices and/or components, fewer components, different components, different arrangements, and so forth.

In some implementations, the discovery engine 112 may perform discovery of all devices in the network system 100. Further, the device database 118 may be a data structure to store information regarding each of the discovered devices. Such information may include device identifiers, device configuration, storage configuration, namespaces, data locations, network connections, status, performance, and so forth. In some implementations, the discovery engine 112 may obtain the discovery information via a registration process initiated by the devices. For example, when a new client device 120 is added to the network system 100, the client device 120 may discover (e.g., via a search function) the central controller 110, and may initiate a registration with the central controller 110 (via the discovery engine 112). Further, upon registering the new client device 120, the discovery engine may add an identifier (and other information) for the new client device 120 to the device database 118. However, in other implementations, the discovery engine 112 may obtain the discovery information by polling the client devices in the network system 100.

In some implementations, the configuration engine 114 may provide configuration of zones in the network system 100. For example, the configuration engine 114 may receive user inputs or commands to specify zone rules, where each zone rule identifies a subset of devices 120 that can communicate with each other (also referred to herein as a “zone”). In some implementations, a switch device 130 may determine that a received packet matches an existing zone rule, and in response may forward the packet to a destination device 120.

In some implementations, the client engine 115 may provide each client device 120 with an identifier (also referred to herein as a “client identifier”) that uniquely identifies the client device 120. For example, when a client device 120 is initially registered with the storage network 100 (e.g., by sending a registration request to the discovery engine 112), the client engine 115 may generate a client identifier for that client device 120. In some implementations, the client identifier may be a local identifier (i.e., an identifier that is configured to be unique within a single network system). The client identifier may be stored in the central controller 110 (e.g., in the device database 118) and/or in the client device 120 (e.g., in persistent storage included in the client device 120).

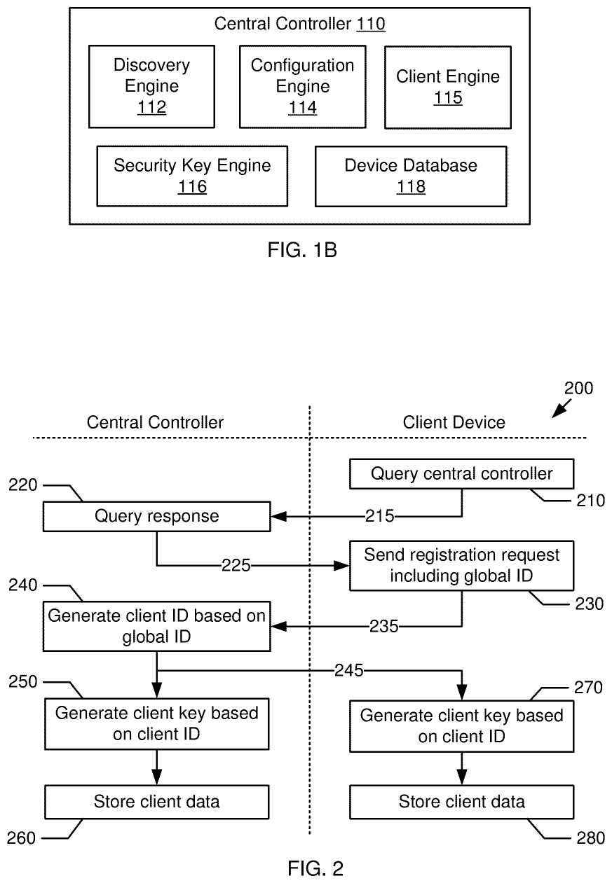

In some implementations, the client engine 115 and/or the client device 120 may use the client identifier to generate a secret value (also referred to herein as a “client key”) that is usable to authenticate communications between that client device 120 and the central controller 110. For example, the client key for a client device 120 may be generated by applying a key derivation function to the client identifier for that client device 120. An example operation for generating a client key is described below with reference to FIG. 2

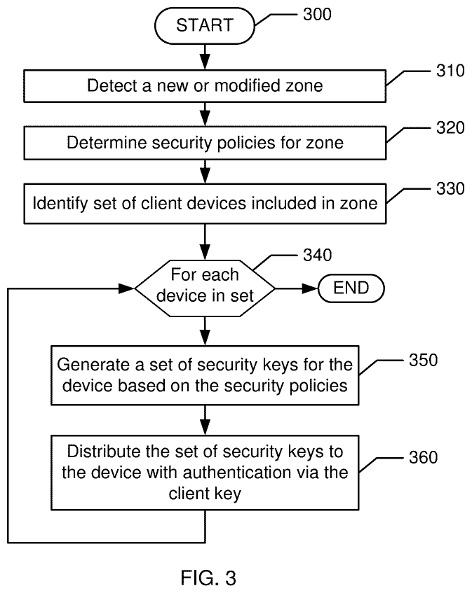

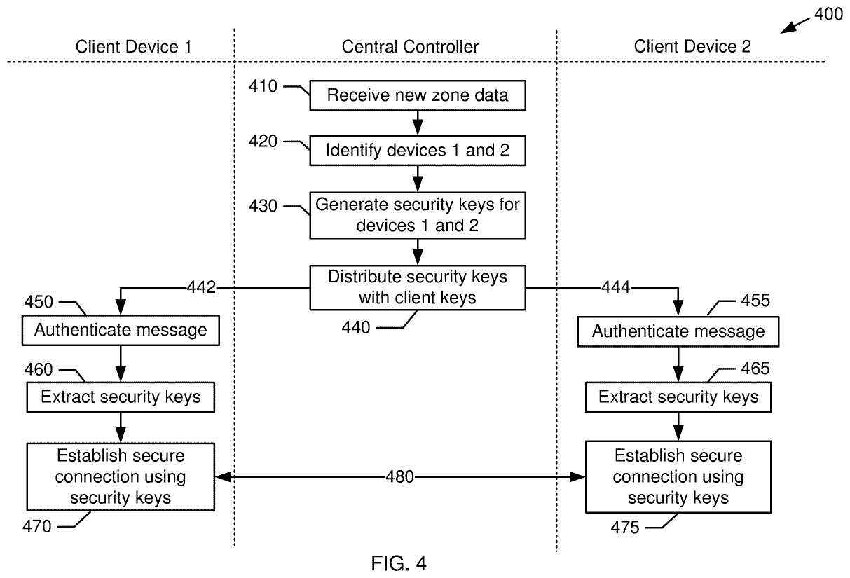

In some implementations, the security key engine 116 may detect a zone change (e.g., a new zone or a modification to an existing zone) in the storage network 100, and in response may distribute the appropriate security keys based on the zone change. For example, the security key engine 116 may identify the devices 120 included in the zone, and may determine the security policies specified for the zone. The security key engine 116 may then generate security keys for the devices 120 that are allowed to communicate in the zone. Further, the security key engine 116 may distribute the security keys via secure messages sent to the devices 120. In some implementations, the secure message sent to a device 120 may include the agent key of the receiving device 120, thereby allowing the device 120 to authenticate the secure message as being sent from the central controller 110. An example process for generating and distributing the security keys is described below with reference to FIGS. 3-4. Further, in some implementations, the secure message from the central controller 110 may also (or instead) be sent via an encrypted connection to the device 120 (e.g., using a Hypertext Transfer Protocol Secure (HTTPS) connection). In some implementations, the central controller 110 may use a particular communication port (e.g., a Transmission Control Protocol (TCP) port) that is designated or reserved for distribution of security keys to the devices 120.

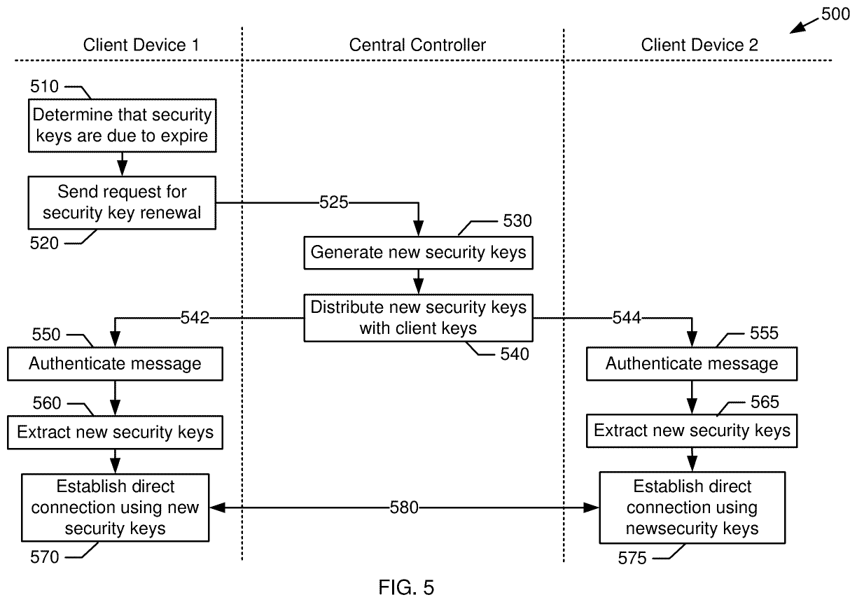

In some implementations, the security key engine 116 may generate security keys that are only valid until expiration. For example, a security key may only be usable for a specified time period (e.g., from creation of the security key), or until reaching a specified date and/or time. In some implementations, the security key engine 116 may detect (or be notified of) the upcoming expiration of a security key, and in response may generate and distribute a new security key to replace the expiring security key. An example operation for replacing expiring security keys is described below with reference to FIG. 5.

### FIG. 2—Example Operation for Generating a Client Key

FIG. 2 shows an example operation 200 for generating a client key, in accordance with some implementations. The operation 200 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth.

As shown in FIG. 2, the operation 200 may be performed by a central controller (e.g., central controller 110 shown in FIG. 1A) and a single client device (e.g., client device 120A shown in FIG. 1A). However, it is contemplated that the same (or similar) operation 200 may be performed for any number of client devices.

At block 210, the client device sends a discovery query 215 (e.g., a multicast Domain Name System (mDNS) query) to the central controller. At block 220, the central controller sends a query response 225 to the client device. In some examples, the query response 225 may include information (e.g., “KDS”) indicating that the central controller provides a key discovery service to devices in a local network (e.g., network system 100 shown in FIG. 1A).

At block 230, the client device sends a registration request 235 to the central controller. In some implementations, the registration request 235 may include a global identifier of the client device. As used herein, a “global identifier” refers to an identifier that is unique across multiple network systems or domains (e.g., a NVMe Qualified Name (NQN)). At block 240, the central controller generates, based on the global identifier of the client device, a client identifier of the client device. Further, the central controller sends a message 245 including the client identifier to the client device. In some implementations, the client identifier may be a local identifier (i.e., an identifier that is configured to be unique within a single network system).

At block 250, the central controller generates, based on the client identifier of the client device, a client key for the client device. Further, at block 270, the client device generates the same client key based on the client identifier. For example, the client device and the central controller may each generate the same client key by applying a key derivation function (e.g., a key derivation function based on Hashed Message Authentication Code (HMAC)) to the client identifier for the client device. Further, in some implementations, the client device and the central controller may each generate the same client key by applying a key derivation function to a combination of the global identifier and the client identifier of the client device

At block 260, the central controller may store client data (e.g., the global identifier, the client identifier, and/or the client key) in a device database (e.g., device database 118 shown in FIG. 1B). Further, at block 280, the client device may store the client data (e.g., in persistent storage included in the client device).

### FIGS. 3-4—Example Process for Generating and Distributing Security Keys

FIG. 3 shows an example process 300 for generating and distributing security keys, in accordance with some implementations. The process 300 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth.

Block 310 may include detecting a new or modified zone. Block 320 may include determining security policies for the zone. Block 330 may include identifying a set of client devices included in the zone.

At block 340, a loop (defined by blocks 340, 350, 360) may be entered to process each client device in the identified set of client devices. Block 350 may include generating a set of security keys for the device based on the security policies. Block 360 may include distributing the set of security keys to the device with authentication via the client key. At block 340, a loop (defined by blocks 340, 350, 360) may be entered to process each client device. After processing all client devices of the identified set, the process 300 may be completed.

Referring now to FIG. 4, shown is an example operation 400, in accordance with some implementations. The operation 400 may correspond generally to an example implementation of the process 300 (shown in FIG. 3). For the sake of illustration, the example operation 400 is shown in FIG. 4 as being performed by a central controller (e.g., central controller 110 shown in FIG. 1A) and two client devices (e.g., client devices 120A and 120B shown in FIG. 1A). However, it is contemplated that the same (or similar) operation 400 may be performed for any number of client devices.

As shown in FIG. 4, at block 410, the central controller receives configuration data (e.g., via user input of zone rules) for a new zone in a network system (e.g., network system 100 shown in FIG. 1A). In response, the central controller determines the zone rules and security policies for the new zone, including which types of devices can communicate with each other (e.g., host to controller), use of encryption and/or authentication, type(s) of encryption and/or authentication (e.g., DH-HMAC-CHAP protocols, TLS protocols), and so forth.

At block 420, the central controller identifies client devices 1 and 2 as the set of client device in the new zone. At block 430, the central controller generates security keys for the client devices 1 and 2. In some implementations, the central controller generates a different set of security keys for each client device. For example, the central controller generates a first set of security keys for client device 1, the first set including a self-key for client device 1 and a partner key for client device 2. Further, the central controller generates a second set of security keys for client device 2, the second set including a self-key for client device 2 and a partner key for client device 1.

In some implementations, the security keys may be generated using mechanisms like Key Derivation Function (KDF or Hashed KDF) or Hashed Message Authentication Code (HMAC) Algorithms. Further, in some implementations, the security keys may only be valid for a specified lifetime period (e.g., from creation of the security key), or until reaching a specified expiration date and/or time.

At block 440, the central controller distributes the different sets of security keys in messages 442, 444 sent to clients 1 and 2, respectively. The message 442 sent to client device 1 includes the client key for client device 1, and the message 444 sent to client device 2 includes the client key for client device 2. At block 450, the client device 1 authenticates the first message 442 by determining that it includes the correct client key for client device 1. Similarly, at block 455, the client device 2 authenticates the second message 444 by determining that it includes the correct client key for client device 2.

At block 460, after authenticating the first message 442, the client device 1 extracts the set of security keys for client device 1 from the first message 442. Similarly, at block 465, the client device 2 extracts the set of security keys for client device 2 from the second message 444. At blocks 470 and 475, the client devices 1 and 2 use their respective security keys to establish a secure connection 480 to each other. For example, the client device 1 may extract a partner key for client device 2 from the first message 442, and may include that partner key in communication sent to the client device 2. Further, the client device 2 may extract a self-key from the second message 444, and may use include that self-key to authenticate the communication received from the client device 1. Other examples are possible.

### FIG. 5—Example Operation for Replacing Expiring Security Keys

FIG. 5 shows an example operation 500 for replacing expiring security keys, in accordance with some implementations. The operation 500 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth.

As shown in FIG. 5, the operation 500 may be performed by a central controller (e.g., central controller 110 shown in FIG. 1A) and two client devices (e.g., client devices 120A and 120B shown in FIG. 1A). However, it is contemplated that the same (or similar) operation 500 may be performed for any number of client devices.

At block 510, the client device 1 determine that the security keys for a particular zone (e.g., a zone including client devices 1 and 2) are due to expire within a specified time period. For example, the client device 1 may determine that the time period remaining until reaching the expiration of a current set of security keys (e.g., previously received from the central controller) is less than a particular threshold time period (e.g. one day, one week, and so forth). In response to this determination, at block 520, the client device 1 sends a request 525 for a renewal of the security keys to the central controller.

At block 530, the central controller generates a new set of security keys for the particular zone. In some implementations, the new security keys may be generated using mechanisms like Key Derivation Function (KDF or Hashed KDF) or Hashed Message Authentication Code (HMAC) Algorithms. At block 540, the central controller distributes the new security keys in messages 542, 544 sent to clients 1 and 2, respectively. The message 542 sent to client device 1 includes the client key for client device 1, and the message 544 sent to client device 2 includes the client key for client device 2. At block 550, the client device 1 authenticates the message 542 by determining that it includes the correct client key for client device 1. Similarly, at block 555, the client device 2 authenticates the message 544 by determining that it includes the correct client key for client device 2.

At block 560, after authenticating the message 542, the client device 1 extracts the new set of security keys for client device 1 from the message 542. Similarly, at block 565, the client device 2 extracts the new set of security keys for client device 2 from the second message 544. At blocks 570 and 575, the client devices 1 and 2 begin using their new security keys to establish a secure connection 580 to each other.

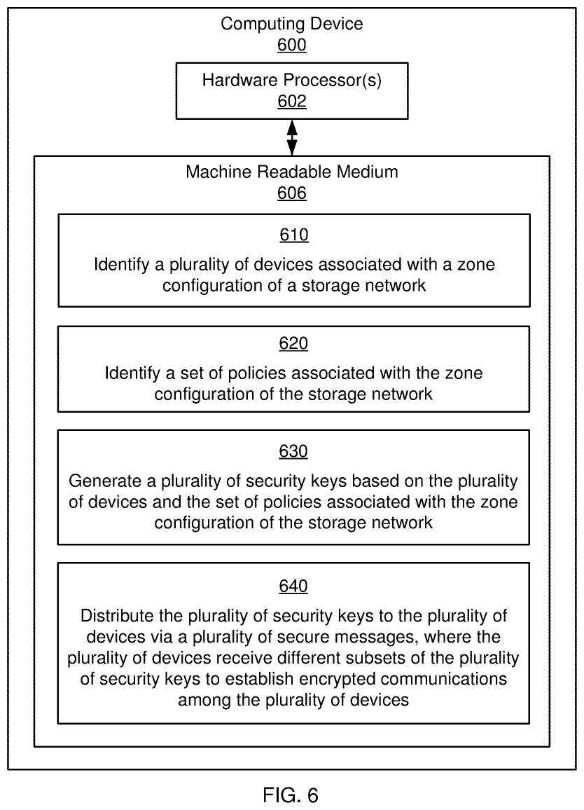

### FIG. 6—Example Computing Device

FIG. 6 shows a schematic diagram of an example computing device 600. In some examples, the computing device 600 may correspond generally to some or all of the central controller 110 (shown in FIGS. 1A-1B). As shown, the computing device 600 may include a hardware processor 602 and machine-readable storage 605 including instructions 610-640. The machine-readable storage 605 may be a non-transitory medium. The instructions 610-640 may be executed by the hardware processor 602, or by a processing engine included in hardware processor 602.

Instruction 610 may be executed to identify a plurality of devices associated with a zone configuration of a storage network. Instruction 620 may be executed to identify a set of policies associated with the zone configuration of the storage network. For example, referring to FIG. 4, at block 410, the central controller receives configuration data for a new zone in a network system. In response, the central controller determines the zone rules and security policies for the new zone. Further, at block 420, the central controller identifies client devices 1 and 2 as the set of client device in the new zone.

Referring again to FIG. 6, instruction 630 may be executed to generate a plurality of security keys based on the plurality of devices and the set of policies associated with the zone configuration of the storage network. For example, referring to FIG. 4, at block 430, the central controller generates different sets of security keys security keys for the client devices 1 and 2. In some implementations, the security keys may be generated using a cryptographic protocol. Further, in some implementations, the security keys may only be valid for a specified lifetime period (e.g., from creation of the security key), or until reaching a specified expiration date and/or time.

Referring again to FIG. 6, instruction 640 may be executed to distribute the plurality of security keys to the plurality of devices via a plurality of secure messages, where the plurality of devices receive different subsets of the plurality of security keys to establish encrypted communications among the plurality of devices. For example, referring to FIG. 4, at block 440, the central controller distributes the different sets of security keys in messages 442, 444 sent to clients 1 and 2, respectively. At block 450, the client device 1 authenticates the first message 442 by determining that it includes the correct client key for client device 1. At block 455, the client device 2 authenticates the second message 444 by determining that it includes the correct client key for client device 2. At block 460, the client device 1 extracts the set of security keys for client device 1 from the first message 442. At block 465, the client device 2 extracts the set of security keys for client device 2 from the second message 444. At blocks 470 and 475, the client devices 1 and 2 use their respective security keys to establish a secure connection 480 to each other.

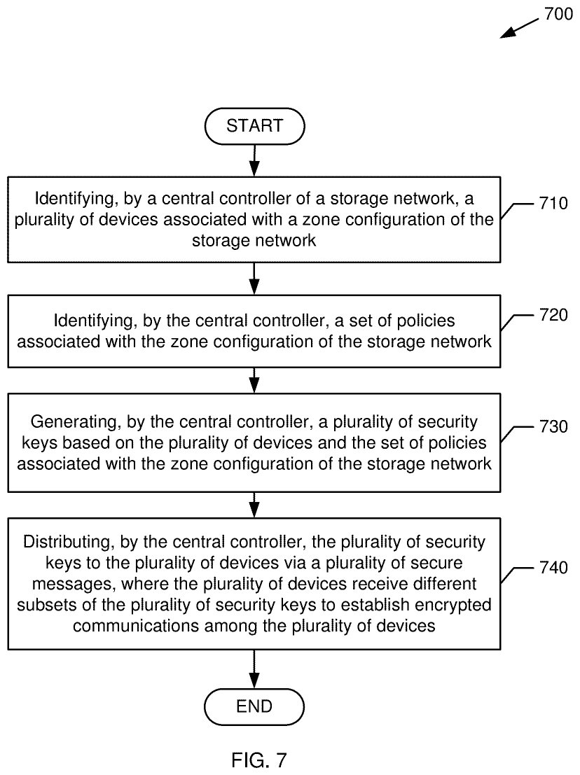

### FIG. 7—Example Process

FIG. 7 shows an example process 700, in accordance with some implementations. In some examples, the process 700 may be performed using a central controller 110 (shown in FIGS. 1A-1B). The process 700 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth. However, other implementations are also possible.

Block 710 may include identifying, by a central controller of a storage network, a plurality of devices associated with a zone configuration of the storage network. Block 720 may include identifying, by the central controller, a set of policies associated with the zone configuration of the storage network.

Block 730 may include generating, by the central controller, a plurality of security keys based on the plurality of devices and the set of policies associated with the zone configuration of the storage network. Block 740 may include distributing, by the central controller, the plurality of security keys to the plurality of devices via a plurality of secure messages, where the plurality of devices receive different subsets of the plurality of security keys to establish encrypted communications among the plurality of devices. Blocks 710-740 may correspond generally to the examples described above with reference to instructions 610-640 (shown in FIG. 6).

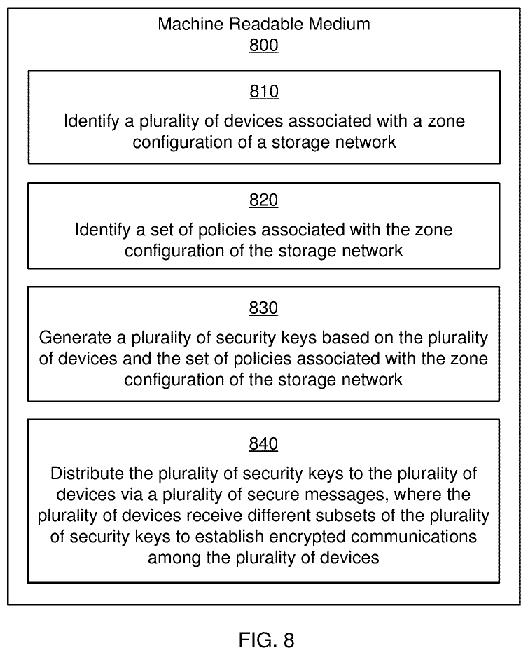

### FIG. 8—Example Machine-Readable Medium

FIG. 8 shows a machine-readable medium 800 storing instructions 810-840, in accordance with some implementations. The instructions 810-840 can be executed by a single processor, multiple processors, a single processing engine, multiple processing engines, and so forth. The machine-readable medium 800 may be a non-transitory storage medium, such as an optical, semiconductor, or magnetic storage medium. The instructions 810-840 may correspond generally to the examples described above with reference to instructions 610-640 (shown in FIG. 6).

Instruction 810 may be executed to identify a plurality of devices associated with a zone configuration of a storage network. Instruction 820 may be executed to identify a set of policies associated with the zone configuration of the storage network.

Instruction 830 may be executed to generate a plurality of security keys based on the plurality of devices and the set of policies associated with the zone configuration of the storage network. Instruction 840 may be executed to distribute the plurality of security keys to the plurality of devices via a plurality of secure messages, where the plurality of devices receive different subsets of the plurality of security keys to establish encrypted communications among the plurality of devices.

In accordance with some implementations described herein, a central controller may provide a Key Discovery Service (KDS) to generate and distribute security keys to devices in a storage network. Each client device in the storage network may be assigned a client key to authenticate messages from the central controller. The central controller may determine which client devices are allowed to communicate with each other in each zone of the storage network, and may also determine the security techniques to be applied to such communications. The central controller may then generate the appropriate set of security keys for each client device, and may distribute the sets of security keys to the client devices in messages that are authenticated via the client keys. In this manner, the central controller may automatically generate and distribute the appropriate security keys to multiple client devices in a secure manner. Accordingly, some implementations described herein may improve the use and management of security keys in the storage network.

Note that, while FIGS. 1A-8 show various examples, implementations are not limited in this regard. For example, referring to FIG. 1A, it is contemplated that the network system 100 may include additional devices and/or components, fewer components, different components, different arrangements, and so forth. In another example, it is contemplated that the functionality of the central controller 110 described above may be included in any another engine or software of the network system 100. Other combinations and/or variations are also possible.

Data and instructions are stored in respective storage devices, which are implemented as one or multiple computer-readable or machine-readable storage media. The storage media include different forms of non-transitory memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices.

Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

What is claimed is:

1. A computing device comprising:
a processor; and
a machine-readable storage storing instructions, the instructions executable by the processor to:
identify a plurality of devices associated with a zone configuration of a storage network;
identify a set of policies associated with the zone configuration of the storage network;
generate a plurality of security keys based on the plurality of devices and the set of policies associated with the zone configuration of the storage network; and
distribute the plurality of security keys to the plurality of devices via a plurality of secure messages, wherein the plurality of devices receive different subsets of the plurality of security keys to establish encrypted communications among the plurality of devices.

2. The computing device of claim 1, including instructions executable by the processor to:
receive a registration request from a first device of the storage network; and
assign a client identifier to the first device, wherein the first device is included in a first zone of the storage network, wherein the zone configuration is associated with the first zone, and wherein the first zone includes the plurality of devices.

3. The computing device of claim 2, including instructions executable by the processor to:
generate, using the client identifier and a global unique identifier of the first device, a first client key for the first device; and
send a first secure message to the first device, wherein the first secure message includes the first client key and a first set of security keys for the first device, and wherein the first device authenticates the first secure message using the first client key.

4. The computing device of claim 3, wherein the first set of security keys comprises:
a self-key for the first device; and
a set of partner keys for other devices included in the first zone.

5. The computing device of claim 3, wherein the global identifier of the first device is Non-Volatile Memory Express Qualified Name (NQN) of the first device.

6. The computing device of claim 2, including instructions executable by the processor to:
monitor for changes to the zone configuration of the first zone; and
identify the plurality of devices in response to a detection of the change to the zone configuration of the first zone.

7. The computing device of claim 1, including instructions executable by the processor to:
assign expiration dates for the plurality of security keys;
receive, from at least one of the plurality of devices, a renewal request to renew the plurality of security keys; and
in response to a receipt of the renewal request, generate new security keys based on the plurality of devices and the set of policies.

8. A method comprising:
identifying, by a central controller of a storage network, a plurality of devices associated with a zone configuration of the storage network;
identifying, by the central controller, a set of policies associated with the zone configuration of the storage network;
generating, by the central controller, a plurality of security keys based on the plurality of devices and the set of policies associated with the zone configuration of the storage network; and
distributing, by the central controller, the plurality of security keys to the plurality of devices via a plurality of secure messages, wherein the plurality of devices receive different subsets of the plurality of security keys to establish encrypted communications among the plurality of devices.

9. The method of claim 8, comprising:
receiving, by the central controller, a registration request from a first device of the storage network; and
assigning, by the central controller, a client identifier to the first device, wherein the first device is included in a first zone of the storage network, wherein the zone configuration is associated with the first zone, and wherein the first zone includes the plurality of devices.

10. The method of claim 9, comprising:
generating, using the client identifier and a global unique identifier of the first device, a first client key for the first device; and
sending a first secure message from the central controller to the first device, wherein the first secure message includes the first client key and a first set of security keys for the first device.

11. The method of claim 10, comprising:
receiving, by the first device from the central controller, the first secure message;
extracting, by the first device, the first client key from the first secure message;
authenticating, by the first device, the first secure message using the first client key;
in response to authenticating the secure message using the first client key, extracting, by the first device, the first set of security keys from the first secure message; and
establishing, by the first device, encrypted communications with other devices of the plurality of devices using the first set of security keys.

12. The method of claim 10, wherein the first set of security keys comprises:
a self-key for the first device; and
a set of partner keys for other devices included in the first zone.

13. The method of claim 10, comprising:
determining, by the first device, that the first set of security keys are due to expire within a specified time period; and
sending, by the first device to the central controller, a renewal request to renew the plurality of security keys.

14. The method of claim 13, comprising:
receiving, by the central controller, the renewal request from the first device; and
in response to a receipt of the renewal request, generating, by the central controller, new security keys based on the plurality of devices and the set of policies.

15. A non-transitory machine-readable medium storing instructions that upon execution cause a controller to:
identify a plurality of devices associated with a zone configuration of a storage network;
identify a set of policies associated with the zone configuration of the storage network;
generate a plurality of security keys based on the plurality of devices and the set of policies associated with the zone configuration of the storage network; and
distribute the plurality of security keys to the plurality of devices via a plurality of secure messages, wherein the plurality of devices receive different subsets of the plurality of security keys to establish encrypted communications among the plurality of devices.

16. The non-transitory machine-readable medium of claim 15, including instructions that upon execution cause the controller to:
receive a registration request from a first device of the storage network; and
assign a client identifier to the first device, wherein the first device is included in a first zone of the storage network, wherein the zone configuration is associated with the first zone, and wherein the first zone includes the plurality of devices.

17. The non-transitory machine-readable medium of claim 16, including instructions that upon execution cause the controller to:
generate, using the client identifier and a global unique identifier of the first device, a first client key for the first device; and
send a first secure message to the first device, wherein the first secure message includes the first client key and a first set of security keys for the first device, and wherein the first device authenticates the first secure message using the first client key.

18. The non-transitory machine-readable medium of claim 17, wherein the first set of security keys comprises:
a self-key for the first device; and
a set of partner keys for other devices included in the first zone.

19. The non-transitory machine-readable medium of claim 16, including instructions that upon execution cause the controller to:
monitor for changes to the zone configuration of the first zone; and
identify the plurality of devices in response to a detection of the change to the zone configuration of the first zone.

20. The non-transitory machine-readable medium of claim 15, including instructions that upon execution cause the controller to:
assign expiration dates for the plurality of security keys;
receive, from at least one of the plurality of devices, a renewal request to renew the plurality of security keys; and
in response to a receipt of the renewal request, generate new security keys based on the plurality of devices and the set of policies.
